(19) United States
(12) Patent Application Publication
(10) Pub. No.: US 2008/0131182 A1
(43) Pub. Date: Jun. 5, 2008

(54) Print instructing apparatus, print system and computer-readable medium

(75) Inventor: Ryousuke Okajima, Hachioji-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 11/977,210

(22) Filed: Oct. 23, 2007

(30) Foreign Application Priority Data
Nov. 30, 2006 (JP) 2006-323755

(51) Int. Cl. B41J 11/44

(52) U.S. Cl. 400/76

(57) ABSTRACT

Disclosed is a print instructing apparatus including: a tab area information obtaining unit to obtain tab area information on a tab area of a tab sheet from an external apparatus; and a display controlling unit to control a display unit to display based on the obtained tab area information a print setting screen to configure a setting of the tab sheet.

### CROSS-REFERENCE TO RELATED APPLICATIONS

The present U.S. patent application claims priority under the Paris Convention of Japanese Patent Application No. 2006-323755 filed on Nov. 30, 2006 to the Japanese Patent Office, which shall be a basis for correcting mistranslations.

### BACKGROUND

1. Field of the Invention

The present invention relates to a print instructing apparatus, a printing system and a computer-readable medium which are used to print tab sheets.

2. Description of Related Art

Image forming apparatuses such as copying machines, printers, etc. have been recently multifunctioned, and a technique of feeding tab sheets to designated pages and printing indices in tab areas of the tab sheets has been also used.

In general, print setting of tab sheets is carried out in a printer driver function of a personal computer (hereinafter referred to as “PC”) connected to an image forming apparatus. FIG. 13 shows an example of a related tab sheet setting screen 30. The tab sheet setting screen 30 is provided with a sheet size setting area 31, an index number setting area 32, an upper margin setting area 33, a tab clearance setting area 34 and a lower margin setting area 35 as shown in FIG. 13. When printing is carried out on tab sheets, the sheet size, the number of the indices (index number), the upper margin, the tab clearance and the lower margin are input with respect to each set of tab sheets. As shown in FIG. 14, the upper margin defines a length of a side edge of a sheet, in which it defines the upper portion of the tab area of the first page in a set of tab sheets. The lower margin defines a length of a side edge of a sheet, in which it defines the lower portion of the tab area of the last page in a set of tab sheets, and the tab clearance defines the clearance between the tab areas of the respective tab sheets.

When printing is carried out on a tab sheet, it is required for a user to measure the tab position of each tab sheet and manually input a measured numerical value on the tab sheet setting screen 30 as shown in FIG. 13. Numerical values must be input to the millimeter level with respect to the upper margin, the tab clearance and the lower margin, and this input work is cumbersome.

In view of the foregoing situation, a print system of reading tab sheets to obtain and hold tab area information in an image forming apparatus has been proposed (see Japanese Patent Application Laid-Open Publication No. 2004-199359, and hereinafter referred to as “Patent Document 1”). According to this print system, an index character string transmitted from a print-instructing PC is enlarged or reduced to the size corresponding to a tab area on the basis of tab area information, arranged according to an indicated character arrangement method in an image forming apparatus, and then printed.

According to the print system described in the Patent Document 1, print lay-out for the tab sheets is automatically changed on the basis of the tab area information at the image forming apparatus. Therefore, the print lay-out which is set or checked on a printer driver of a PC by a user is changed, and thus there is a case where a print result intended by the user cannot be obtained. Particularly, when a preview screen relating to a tab setting is displayed on the printer driver, there is such a case that an intended print result cannot be obtained in spite of a user's visual check on the preview screen, that is, the original purpose of the preview screen is impaired.

### SUMMARY

The present invention has been made in consideration of the above problems. It is a major object of the present invention to reduce a load imposed on a user with respect to print instruction of tab sheets and also to provide a print setting screen based on tab area information concerning tab areas of tab sheets.

To achieve at least one of the abovementioned objects, a print instructing apparatus reflecting one aspect of the present invention comprises:

a tab area information obtaining unit to obtain tab area information on a tab area of a tab sheet from an external apparatus; and

a display controlling unit to control a display unit to display based on the obtained tab area information a print setting screen to configure a setting of the tab sheet.

It is desirable that in the print instructing apparatus, the print setting screen includes a tab sheet preview screen.

It is desirable that the print instructing apparatus further comprises:

an input unit to receive an input of a character or image to be printed in the tab area;

a print data generating unit to generate based on the input character or image print data to print the character or image in the tab area; and

a print data transmitting unit to transmit the generated print data to a print apparatus,

wherein the display controlling unit controls the display unit to display the input character or image in a tab area on the preview screen.

It is desirable that in the print instructing apparatus, the external apparatus comprises an image reading apparatus, and the tab area information is obtained by reading the tab sheet in the image reading apparatus and by detecting the tab area from the read tab sheet.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a diagram showing a system construction of a print system according to a first embodiment;

FIG. 2 is a block diagram showing the internal construction of an image forming apparatus;

FIG. 3 is a diagram showing an example of tab area information;

FIG. 4 is a diagram showing an example of a data format of tab area information;

FIG. 5 is a diagram showing a specific example of tab sheets;

FIG. 6 is a diagram showing the tab area information of the tab sheets shown in FIG. 5;

FIG. 7 is a block diagram showing an internal construction of a PC;

FIG. 8 is a diagram showing a tab print setting screen;

FIG. 9 is a flowchart showing a tab sheet reading processing;

FIG. 10 is a flowchart showing tab area information displaying processing;

FIG. 11 is a flowchart showing index character input processing;

FIG. 12A is a diagram showing a case where FTP is selected on a transmitting method setting screen;

FIG. 12B is a diagram showing a case where SMB is selected on the transmitting method setting screen;

FIG. 12C is a diagram showing a case where E-mail is selected on the transmitting method setting screen;

FIG. 13 is a diagram showing a tab sheet setting screen of a related art; and

FIG. 14 is a diagram showing an upper margin, a lower margin and a tab clearance.

### DETAILED DESCRIPTION OF PREFERRED EMBODIMENTS

### First Embodiment

First, a print system 100 according to a first embodiment will be described.

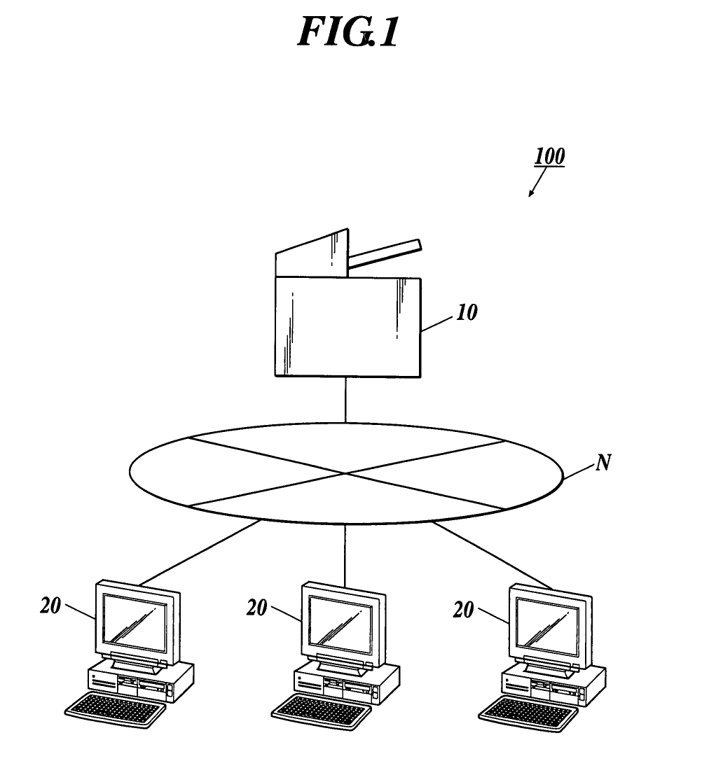

FIG. 1 shows the system structure of the print system 100 according to the first embodiment. As shown in FIG. 1, the print system 100 is configured so that an image forming apparatus 10 and PCs 20 are connected to one another through a network N to enable data transmission/reception among them. The numbers of image forming apparatuses 10 and PCs 20 are not limited.

The network N is an information communication network such as a LAN (Local Area Network), a WAN (Wide Area Network) or the like which is established in a building such as a company, a school or the like. The connection between the apparatuses may be either wired or wireless.

Next, each apparatus constituting the print system 100 will be described.

First, the image forming apparatus 10 will be described.

The image forming apparatus 10 serving as both an image reading apparatus and a print apparatus is an image forming apparatus such as a copying machine, an MFP (Multi-Function Peripheral), a print machine or the like, and has a scanner function of reading an original document, a copying function of copying the document on the basis of the read data of the document and a printer function of receiving print data from the PC 20 through the network N and carrying out printing on the basis of the print data.

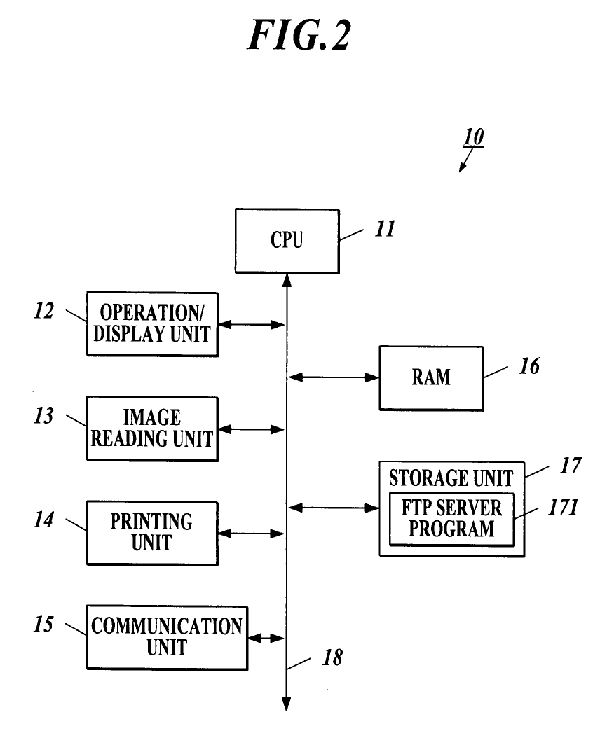

FIG. 2 shows the internal structure of the image forming apparatus 10. As shown in FIG. 2, the image forming apparatus 10 comprises a CPU (Central Processing Unit) 11, an operation/display unit 12, an image reading unit 13, a printing unit 14, a communication unit 15, a RAM (Random Access Memory) 16, a storage unit 17, etc., and these units are connected to one another through a bus 18.

The CPU 11 reads out a system program and various kinds of processing programs stored in the storage unit 17, develops these programs in the RAM 16, and centrally controls the operation of each unit of the image forming apparatus 10 according to the developed programs.

When detection of tab areas of tab sheets is instructed from the operation/display unit 12, the CPU 11 allows the tab sheets placed at the document set position to be successively fed to the image reading unit 13 so that each tab sheet is read. The CPU 11 detects the tab areas based on the image data of the tab sheets and stores the detected tab areas as tab area information in the storage unit 17 in association with the reading order of the tab sheets.

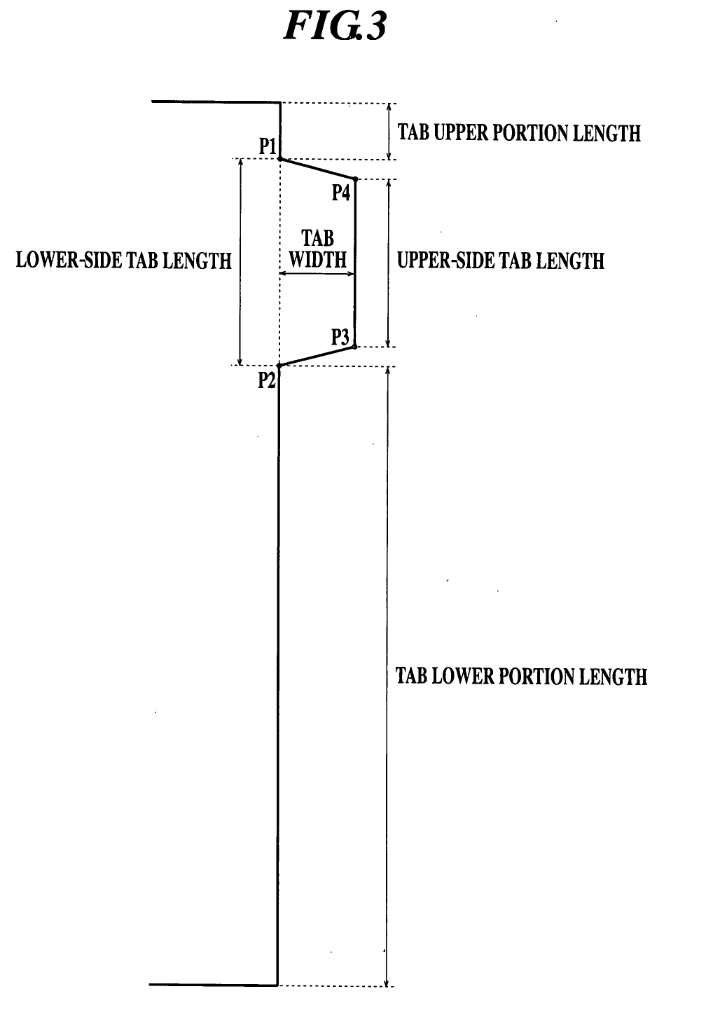

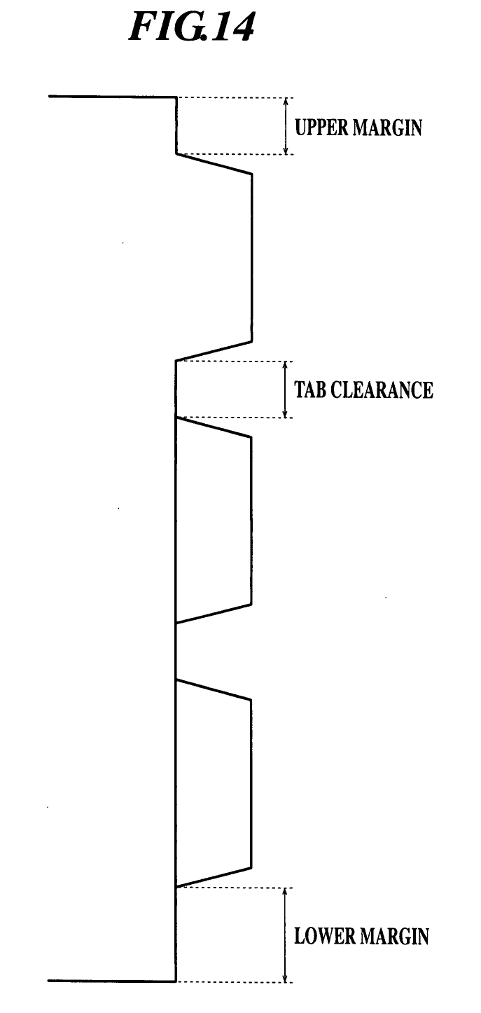

The tab area information means information concerning the tab areas of the tab sheets. The tab area information contains, as shown in FIG. 3, a tab width, an upper-side tab length (the length of the upper side of the tab area), a lower-side tab length (the length of the lower side of the tab area), a tab upper portion length (the length of the side edge of the tab sheet, the upper portion of the tab area), a tab lower portion length (the length of the side edge of the tab sheet, the lower portion of the tab area), etc. Furthermore, the tab area information may contain an upper margin, a tab clearance and a lower margin shown in FIG. 14.

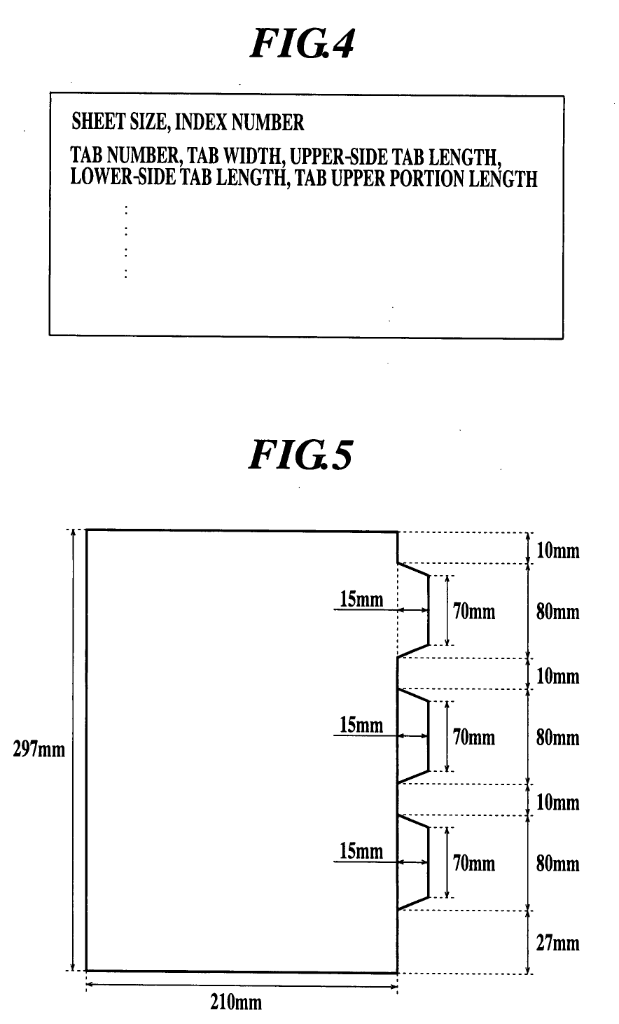

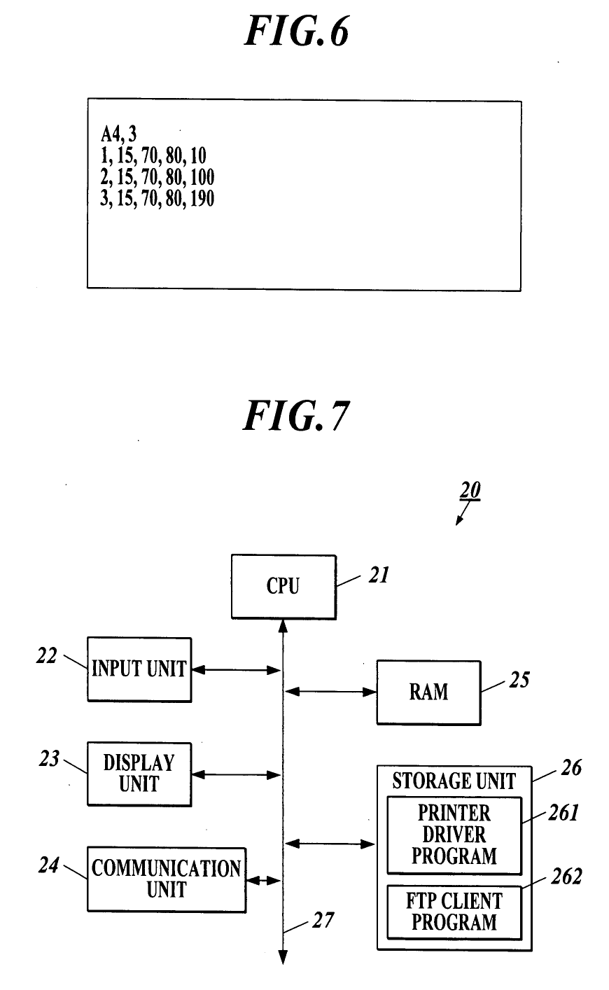

FIG. 4 shows an example of the data format of the tab area information. As shown in FIG. 4, the tab width, the upper-side tab length, the lower-side tab length and tab upper portion length are recorded in association with the tab number (the number indicating the order of each sheet in a set of tab sheets) together with the sheet size of the tab sheets and the number of indices (the number of one set of tab sheets). For example, when one set of three tab sheets each having a sheet size of A4 (297 mm×210 mm) as shown in FIG. 5 is read, tab area information as shown in FIG. 6 is obtained. As shown in FIGS. 5 and 6, the sheet size is “A4”, the number of indices is “3”, and the tab width, the upper-side tab length, the lower-side tab length and the tab upper portion length of the tab number 1 are “15” mm, “70” mm, “80” mm and “10” mm, respectively.

Furthermore, the image forming apparatus 10 is provided with the functionality of an FTP (File Transfer Protocol) server, and a user account and a password for allowing an access from the PC 20 are preset in the image forming apparatus 10. The CPU 11 transmits the tab area information through the communication unit 15 in response to a request from the PC 20 connected through the network N according to an FTP server program 171.

Furthermore, when the print data transmitted from the PC 20 are received, the CPU 11 controls the printing unit 14 on the basis of the received print data to perform printing on tab sheets or normal transfer sheets.

The operation/display unit 12 comprises an LCD (Liquid Crystal Display), and it displays the states of various kinds of operation buttons and the apparatus, the operating condition of each function, etc. on the display screen according to the instruction of a display signal input from the CPU 11. The display screen of the LCD is covered by a pressure-sensitive type (resistance film pressure type) touch panel having transparent electrodes arranged in a reticular pattern. The XY coordinate of a force point which is pushed by a finger, a touch pen or the like on this display screen is detected on the basis of voltage values, and a detected position signal is output as an operation signal to the CPU 11. The operation/display unit 12 is equipped with various kinds of operating buttons such as numeric buttons, a start button, etc., and outputs an operation signal based on the button operation to the CPU 11.

The image reading unit 13 has a contact glass on which the document is placed, and a scanner located below the contact glass, and it reads an image of the document. The scanner comprises a light source, a CCD (Charge Couple Device) image sensor or the like. The document is irradiated with light from the light source and scanned with the light, and reflection light of the scanning light from the document is imaged and photoelectrically converted, whereby the image of the document is read. Here, the image is not limited to image data such as a figure, a photograph or the like, and it may contain text data such as a character(s), a symbol(s) or the like. The image reading unit 13 is further equipped with an ADF (Auto Document Feeder), and it feeds documents placed at the document set position to the scanner position one by one. The image reading unit 13 is further equipped with a sensor (not shown) for detecting the sheet size of the documents, and detects the sheet size of each document placed at the document set position.

The printing unit 14 comprises a photosensitive drum, an electric charging unit for electrically charging the photosensitive drum, an exposure unit for exposing the surface of the photosensitive drum to light on the basis of the image data while scanning the surface of the photosensitive drum with the light, a developing unit for making toner adhere to the photosensitive drum to form a toner image on the photosensitive drum, a transfer unit for transferring the toner image formed on the photosensitive drum to a tab sheet or a normal transfer sheet, a fixing unit for fixing the toner image, a sheet supply unit, etc. The printing unit 14 comprises at least two sheet supply units, that is, a sheet supply unit in which normal transfer sheets are set and a sheet supply unit in which tab sheets are set.

The communication unit 15 is an interface connected to the network N such as a LAN, a WAN or the like to carry out data communication. The communication unit 15 comprises a communication control card such as a LAN card or the like and receives/transmits various kinds of data from/to the PC 20 connected to the network N.

The RAM 16 serves as a temporary storage area for programs read out from the storage unit 17, input/output data, parameters, etc. during the various processing executed and controlled by the CPU 11.

The storage unit 17 comprises a non-volatile semiconductor memory or the like, and stores a system program adapted to the image forming apparatus 10, various kinds of processing programs executable on the system program, data used for various kinds of processing, processing results, etc. The program is stored in a computer-readable program code format, and the CPU 11 successively executes the operations based on the program code concerned. Specifically, the FTP server program 171 is stored in the storage unit 17. Furthermore, the tab area information of the tab sheets which are read by the image reading unit 13 is stored in the storage unit 17.

Next, the PC 20 will be described.

The PC 20 as a print instructing apparatus converts document data or image data created by using application software to data based on a data format which is printable in the image forming apparatus 10 according to a predetermined page description language, adds the converted data with control data for indicating the number of prints, the type of print sheets, the print style (monochrome, color), etc., and transmits these data as print data through the network N to the image forming apparatus 10.

FIG. 7 shows the internal structure of the PC 20. As shown in FIG. 7, the PC 20 comprises a CPU 21, an input unit 22, a display unit 23, a communication unit 24, a RAM 25, a storage unit 26, etc., and the respective units are connected to one another through a bus 27.

The CPU 21 develops a specified program out of various kinds of programs stored in the storage unit 26 into a work area (not shown) in the RAM 25, and centrally controls the respective units according to the program. Furthermore, the CPU 21 stores the processing result into the work memory of the RAM 25, and also it generates display data for displaying the processing result and outputting the display data to the display unit 23. The CPU 21 further controls the storage unit 26 to store the processing result stored in the RAM 25 into a predetermined area.

The CPU 21 executes tab area information display processing and index character input processing according to a printer driver program 261 stored in the storage unit 26.

The PC 20 is provided with the functionality of an FTP client, and an FTP client program 262 is incorporated in the printer driver program 261. A user account and a password (the same as the user account and the password set in the image forming apparatus 10) for retrieving the tab area information from the image forming apparatus 10 are stored in the storage unit 26 in advance, and the CPU 21 logs on the FTP server of the image forming apparatus 10 connected through the network N according to the FTP client program 262 by using the user account and the password. Then, the CPU 21 requests transmission of the tab area information through the communication unit 24 to the image forming apparatus 10, and obtains (downloads) the tab area information transmitted from the image forming apparatus 10.

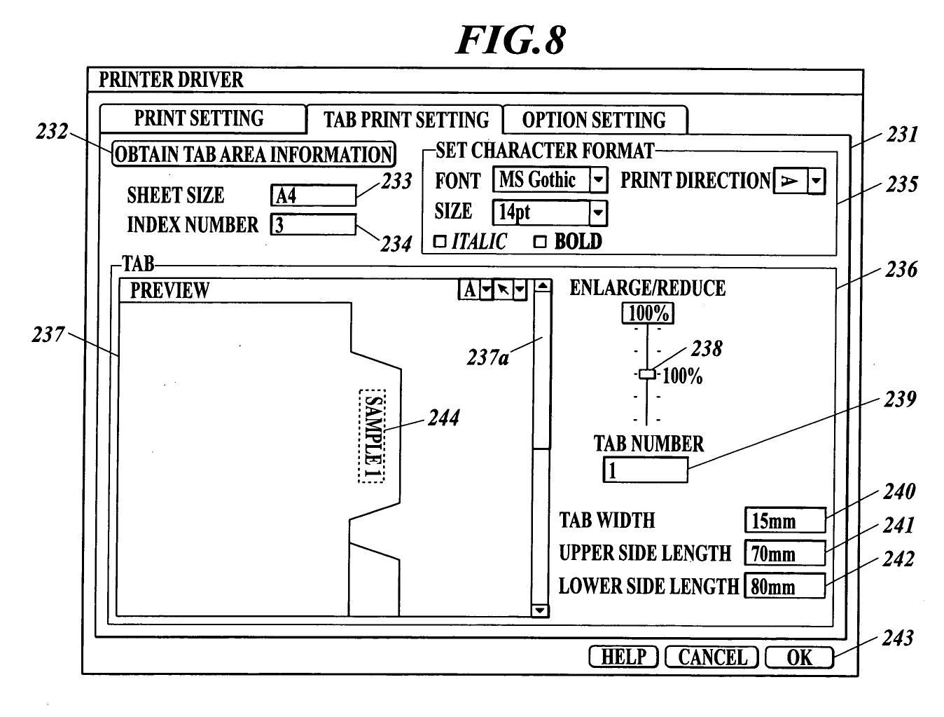

The CPU 21 controls the display unit 23 to display on the basis of the obtained tab area information a tab print setting screen 231 (see FIG. 8) to configure the setting concerning tab sheets. The tab print setting screen 231 contains a tab-sheet preview screen, and the CPU 21 displays a character(s) input from the input unit 22 in each tab area on the tab-sheet preview screen which is displayed on the display unit 23.

The CPU 21 generates print data for printing the character(s) concerned in the tab area on the basis of the character(s) input from the input unit 22, and transmits the generated print data through the communication unit 24 to the image forming apparatus 10.

The input unit 22 is equipped with a keyboard having not only character keys and numeric keys, but also various kinds of function keys, a pointing device such as a mouse or the like, and outputs a press signal corresponding to an operated key and an operating signal corresponding to the operation of the mouse to the CPU 21.

The display unit 23 has a display screen comprising a CRT (Cathode Ray Tube), an LCD or the like, and displays display data on the screen according to the instruction of the display signal input from the CPU 21.

FIG. 8 shows an example of the tab print setting screen 231. This screen is displayed on the display unit 23 when the print setting of tab sheets is carried out. As shown in FIG. 8, the tab print setting screen 231 has a tab area information obtaining button 232, a sheet size display area 233, an index number display area 234, a character format setting area 235 and a tab information display area 246.

The tab area information obtaining button 232 is clicked by operating the mouse of the input unit 22 when tab area information is obtained from the image forming apparatus 10. The sheet size display area 233 is an area in which the sheet size of the tab sheets is displayed when the tab area information is obtained, and the index number display area 234 is an area in which the number of the indices of the tab sheets is displayed when the tab area information is obtained.

The character format setting area 235 is an area for setting the font, size, print direction, etc. of a character(s) to be printed in the tab area. A user sets a format of an input character(s) by operating the input unit 22 to select the format concerned from a pull-down menu or tick a check box of the format.

The tab information display area 236 contains a preview screen display area 237, an enlarging/reducing instructing unit 238, a tab number display area 239, a tab width display area 240, an upper-side tab length display area 241, and a lower-side tab length display area 242. A tab-sheet preview screen is displayed in the preview screen display area 237, on the basis of the tab area information obtained from the image forming apparatus 10. The position of a display position changing instructing unit 237a is moved by operating the input unit 22, whereby the position of the tab sheet image displayed in the preview screen display area 237 can be changed. The enlarging/reducing instructing unit 238 instructs to enlarge/reduce the tab sheet image displayed in the preview screen display area 237.

An OK button 243 at the lower right side of the tab print setting screen 231 is a button for settling input items on the tab print setting screen 231 and instructing print of the tab sheet.

The communication unit 24 shown in FIG. 7 is an interface which is connected to the network N such as a LAN, a WAN or the like to carry out data communication. The communication unit 24 comprises a communication control card such as a LAN card or the like, and transmits/receives various kinds of data to/from the image forming apparatus 10 connected to the network N.

The RAM 25 serves as a temporary storage area for programs read out from the storage unit 26, input or output data, parameters, etc. during the various processing executed and controlled by the CPU 21.

The storage unit 26 has a recording medium (not shown) for storing a system program, various kinds of processing programs adapted to the system concerned, data processed on the basis of each processing program, etc., and this recording medium comprises a magnetic or optical recording medium or a semiconductor memory. The recording medium may be fixedly provided to the storage unit 26, or detachably provided to the storage unit 26. The programs are stored in a computer-readable program code format, and the CPU 21 successively executes the operations based on the program code concerned. Specifically, a printer driver program 261 and an FTP client program 262 are stored in the storage unit 26 for instructing printing to the image forming apparatus 10.

Next, the operation will be described.

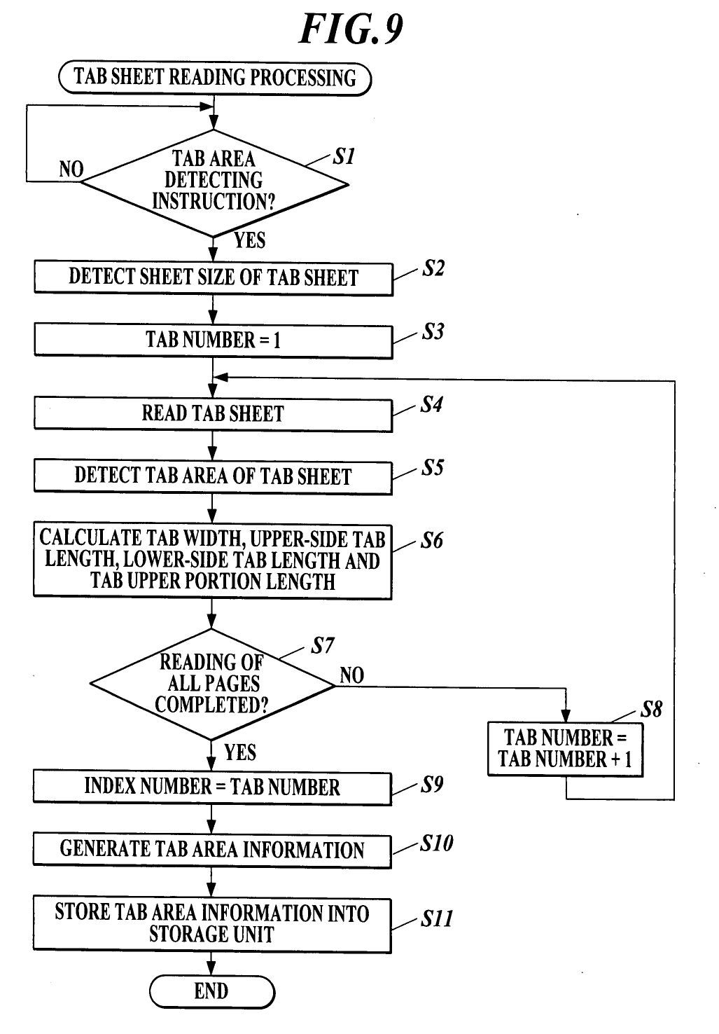

FIG. 9 is a flowchart showing the tab sheet reading processing. This processing is executed when a tab sheet is placed at the document set position and the detection of the tab area of the tab sheet is instructed from the operation/display unit 12 under the control of the CPU 11 of the image forming apparatus 10. The tab sheet reading processing will be described hereunder with reference to FIG. 9.

First, when there is an instruction of detecting the tab area from the operation/display unit 12 (step S1; Yes), the sheet size of the tab sheet placed at the document set position is detected by a sensor provided to the image reading unit 13 (step S2). The detected sheet size is stored in the RAM 16. Here, a tab number counter is set to “1” (step S3).

Subsequently, the tab sheets are successively fed one by one and read by the image reading unit 13 to generate image data (step S4). The tab area is detected from the image data of the read tab sheet by the CPU 11 (step S5), and the tab width, the upper-side tab length, the lower-side tab length and the tab upper portion length of the detected tab area are calculated (step S6). For example, in the image data of the tab sheet, four points indicating the tab area, that is, the position coordinates of P1 to P4 shown in FIG. 3 are detected, and the tab width, the upper-side tab length, the lower-side tab length and the tab upper portion length of the tab area are calculated on the basis of the position coordinates of P1 to P4 and the sheet size detected in step S2. These calculated tab width, upper-side tab length, lower-side tab length and tab upper portion length of the tab area are stored in association with the tab number in the RAM 16.

Here, it is judged whether reading of all the pages is completed or not (step S7). If the reading of all the pages is not completed (step S7; No), the tab number counter is added with “1” (step S8), and then the processing returns to the step S4. The processing of the steps S4 to S8 is repeated until the reading of all the pages is completed.

If the reading of all the pages is completed in step S7 (step S7; Yes), the value of the tab number counter is stored as an index number in the RAM 16 (step S9). Subsequently, on the basis of the sheet size of the tab sheets and the index number stored in the RAM 16 and the tab width, the upper-side tab length, the lower-side tab length and the tab upper portion length which are associated with each tab number and stored in the RAM 16, the tab area information containing these information is generated by the CPU 11 (step S10), and stored in the storage unit 17 (step S11).

Through the above processing, the tab sheet reading processing is finished.

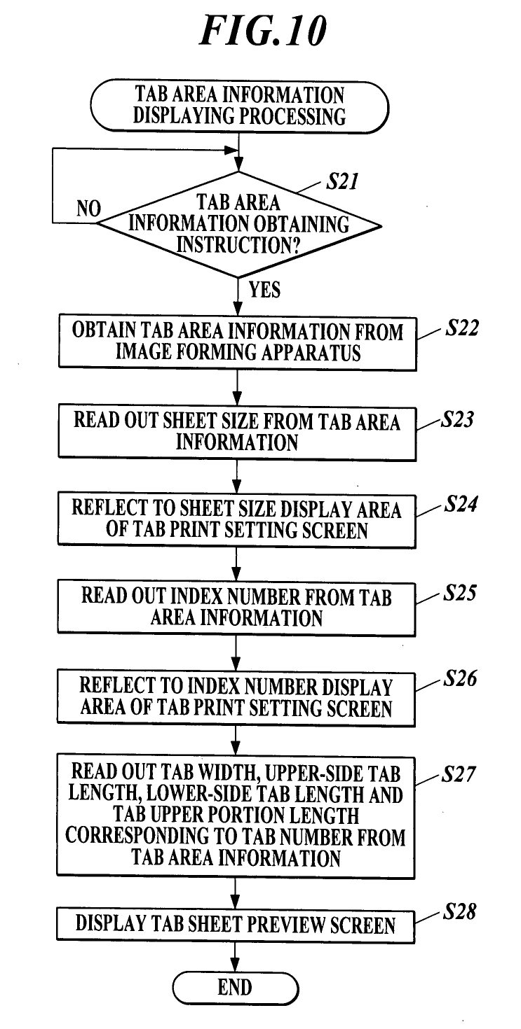

Next, the tab area information display processing will be described with reference to FIG. 10. This processing is the processing of obtaining the tab area information from the image forming apparatus 10 and reflecting the tab area information to the tab print setting screen 231 under the control of the CPU 21 of the PC 20.

First, when the tab area information obtaining button 232 of the tab print setting screen 231 is clicked by operating the mouse of the input unit 22 (step S21; Yes), the tab area information is obtained from the image forming apparatus 10 through the communication unit 24 by the FTP client function (step S22). Specifically, transmission of tab area information is requested to the FTP server of the image forming apparatus 10 through the communication unit 24 by the CPU 21, and the tab area information transmitted from the image forming apparatus 10 is obtained. The obtained tab area information is stored in the storage unit 26.

Subsequently, the sheet size is read out from the obtained tab area information by the CPU 21 (step S23), and it is reflected to the sheet size display area 233 of the tab print setting screen 231 (step S24). Furthermore, the index number is read out from the tab area information by the CPU 21 (step S25), and it is reflected to the index number display area 234 of the tab print setting screen 231 (step S26).

Subsequently, the tab width, the upper-side tab length, the lower-side tab length and the tab upper portion length which are associated with each tab number are read out from the tab area information by the CPU 21 (step S27). Then, on the basis of these information and the sheet size read out in step S23, the display data of one set of tab sheets are generated, and the tab-sheet preview screen is displayed in the preview screen display area 237 (step S28). For example, an image representing a superposed state of one set of tab sheets is displayed.

Through the above processing, the tab area information display processing is finished.

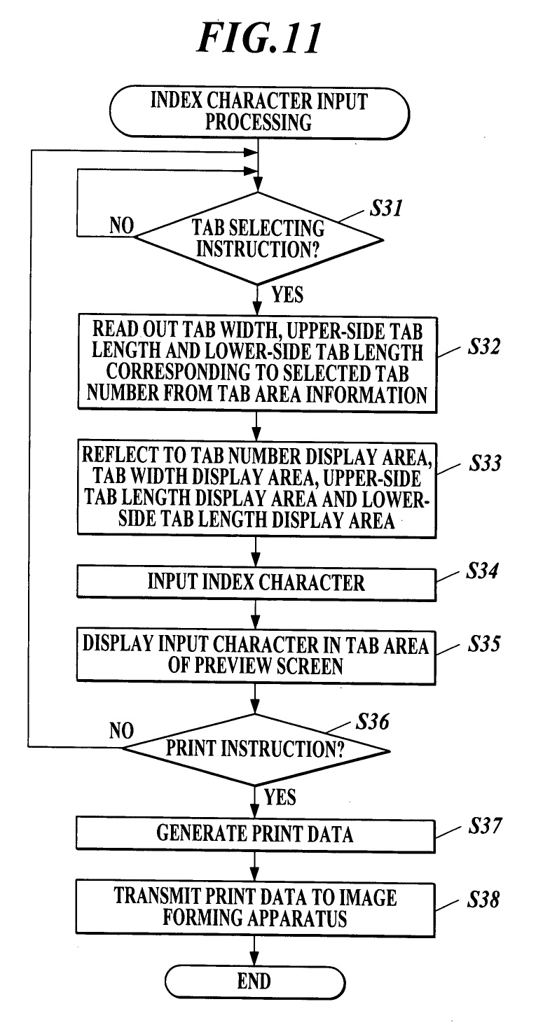

Next, the index character input processing will be described with reference to FIG. 11. This processing is executed under the control of the CPU 21 of the PC 20 when a character(s) to be printed in a tab area is(are) input under the state that the tab print setting screen 231 is displayed on the display unit 23.

First, when a tab area to which a character(s) should be input on the tab sheet preview screen displayed in the preview screen display area 237 is selected by a double-click or the like through the mouse operation of the input unit 22 (step S31; Yes), the tab width, the upper-side tab length and the lower-side tab length which are associated with the tab number of the selected tab area are read out from the tab area information stored in the storage unit 26 by the CPU 21 (step S32), and reflected to the tab number display area 239, the tab width display area 240, the upper-side tab length display area 241 and the lower-side tab length display area 242 (step S33). Then, it is possible to input a character(s) to the character input area of the selected tab area (for example, a character input area 244 of FIG. 8 when the tab area of the tab number 1 is selected).

Subsequently, when a character(s) to be printed in the tab area, that is, the character(s) to be indexed is (are) input from the input unit 22 (step S34), the input character(s) is (are) displayed in the tab area on the preview screen according to the font, the size and the print direction which are set in the character format setting area 235 (step S35).

Here, it is judged whether the OK button 243 of the tab print setting screen 231 is pushed or not, that is, a print instruction based on the input content is given (step S36). If there is no print instruction (step S36; No), the processing returns to the step S31, and the processing of the steps S31 to S36 is repeated to input a character(s) to be printed in another tab area.

When the OK button 243 on the tab print setting screen 231 is pushed to instruct printing in step S36 (step S36; Yes), the CPU 21 generates print data for printing a character(s) in the tab area on the basis of the character(s) input from the input unit 22 (step S37). When normal printing is carried out on portions other than the tab area of the tab sheet, print data containing body text data to be printed at the portions other than the tab area and data to be printed in the tab area are generated. The CPU 21 transmits the generated print data to the image forming apparatus 10 through the communication unit 24 (step S38).

Through the above processing, the index character input processing is finished.

In the image forming apparatus 10, the print data transmitted from the PC 20 are received by the communication unit 15, and printing is carried out on the tab sheets on the basis of the received print data by the printing unit 14.

As described above, according to the print system 100, the tab sheet is read and the tab area is detected from the read tab sheet in the image forming apparatus 10. Consequently, it is unnecessary for a user to measure the tab sheet, and thus the load imposed on the user in the tab sheet print instruction can be reduced. Furthermore, the PC 20 can obtain the tab area information obtained in the image forming apparatus 10 and use the tab area information for the display of the print setting screen 231, so that the tab print setting screen 231 based on the tab area information can be supplied. Furthermore, the PC 20 can supply the print setting screen 231 containing the tab sheet preview screen on the basis of the tab area information. Still furthermore, a character(s) to be printed in the tab area is(are) displayed in the tab area on the preview screen of the tab print setting screen 231 of the PC 20, and thus the same tab-sheet preview screen as the print result can be supplied.

In the first embodiment, the user account and the password when the PC 20 obtains the tab area information from the image forming apparatus 10 are uniquely preset between the image forming apparatus 10 and the PC 20. However, it may be modified so that the user account and the password are arbitrarily set in the image forming apparatus 10, and the set user account and password are input when the tab area information is obtained by the PC 20.

Furthermore, when the tab area information is obtained by the PC 20, an image forming apparatus 10 from which the tab area information is obtained may be determined by inputting the IP address of the image forming apparatus 10.

### <Modification 1>

A modification 1, in which an SMB (Server Message Block) is used as the communication protocol between the image forming apparatus 10 and the PC 20 in place of the FTP will be described. The same constituent elements as the print system 100 according to the first embodiment are represented by the same reference numerals, and the illustrations and the descriptions of the constructions thereof are omitted and the construction and processing which are characteristic of the modification 1 will be described.

An SMB server program is stored in the storage unit 17 of the image forming apparatus 10, and the image forming apparatus 10 is provided with the functionality of the SMB server. Furthermore, a user account and a password for an access from the PC 20 are preset in the image forming, apparatus 10. The CPU 11 transmits tab area information through the communication unit 15 in response to a request from the PC 20 connected through the network N according to the SMB server program.

An SMB client program is stored in the storage unit 26 of the PC 20, and the PC 20 is provided with the functionality of an SMB client. Furthermore, a user account and a password for obtaining tab area information from the image forming apparatus 10 (the same user account and password as set in the image forming apparatus 10) are preset in the PC 20, and the CPU 21 allows the PC 20 to log on the SMB server of the image forming apparatus 10 connected through the network N by using the user account and the password described above according to the SMB client program. The CPU 21 requests transmission of the tab area information to the image forming apparatus 10 through the communication unit 24, and obtains (downloads) the tab area information transmitted form the image forming apparatus 10.

The tab sheet reading processing executed in the image forming apparatus 10, the processing steps of the tab area information display processing after the tab area information is obtained which are executed in the PC 20 and the index character input processing executed in the PC 20 are the same as the first embodiment.

As described above, the PC 20 can obtain the tab area information from the image forming apparatus 10 by using the SMB as a communication protocol between the image forming apparatus 10 and the PC 20.

In the modification 1, the user account and the password when the PC 20 obtains the tab area information from the image forming apparatus 10 are uniquely preset between the image forming apparatus 10 and the PC 20. However, it may be modified so that the user account and the password can be arbitrarily set in the image forming apparatus 10 and the set user account and the set password are input when the tab area information is obtained by the PC 20.

Furthermore, when the tab area information is obtained by the PC 20, the image forming apparatus 10 from which the tab area information is obtained may be determined by inputting the IP address of the image forming apparatus 10 concerned. Furthermore, when the tab area information is obtained by the PC 20, the image forming apparatus 10 on the network N and the folder in the storage unit 17 of the image forming apparatus 10 may be indicated from a network computer of Windows™.

### <Modification 2>

A modification 2, in which the image forming apparatus 10 makes the tab area information open to the public by using an MIB (Management Information Base) will be described. An MIB is an information data base which is open to the public in order for network equipment corresponding to an SNMP (Simple Network Management Protocol) to notify management information to external equipment. The tab area information is defined as a private MIB. The same constituent elements as the print system 100 according to the first embodiment are represented by the same reference numerals, and the illustrations and descriptions of the constructions thereof are omitted. The construction and processing which are characteristic of the modification 2 will be described.

An MIB manager function is installed in the printer driver function of the PC 20. The CPU 21 communicates with the image forming apparatus 10 through a UDP (User Datagram Protocol) communication in response to an instruction of achieving tab area information from the user, and obtains the tab area information stored in the MIB.

The tab sheet reading processing executed in the image forming apparatus 10, the processing steps of the tab area information display processing after the tab area information is obtained which are executed in the PC 20, and the index character input processing executed in the PC 20 are the same as the first embodiment.

As described above, it is possible to make the tab area information open to the public by using an MIB in the image forming apparatus 10 so that the PC 20 may obtain the tab area information from the image forming apparatus 10.

### Second Embodiment

Next, a second embodiment to which the present invention is applied will be described.

The print system according to the second embodiment has a similar construction to the print system 100 according to the first embodiment. Therefore, the same constituent elements are represented by the same reference numerals, and the illustrations and descriptions of the constructions thereof are omitted. The construction and processing which are characteristic of the second embodiment will be described.

In the first embodiment, a case in which the obtaining of the tab area information is instructed from the PC 20 side to the image forming apparatus 10 was described. In the second embodiment, a case in which the transmission of the tab area information is instructed from the image forming apparatus 10 side to the PC 20 is described.

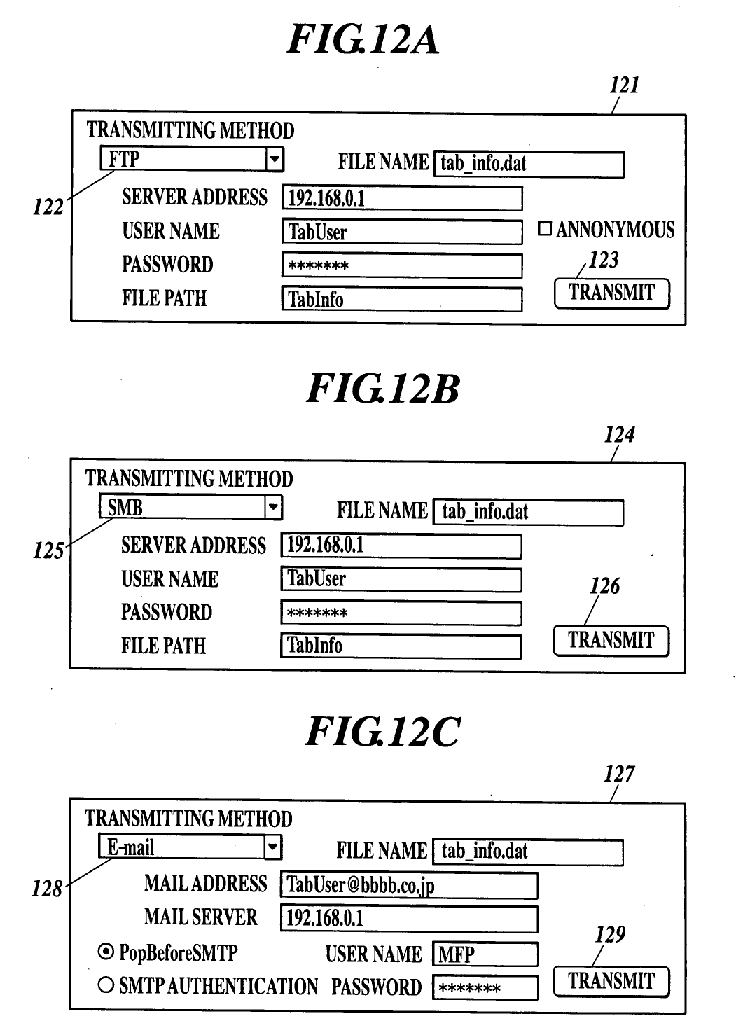

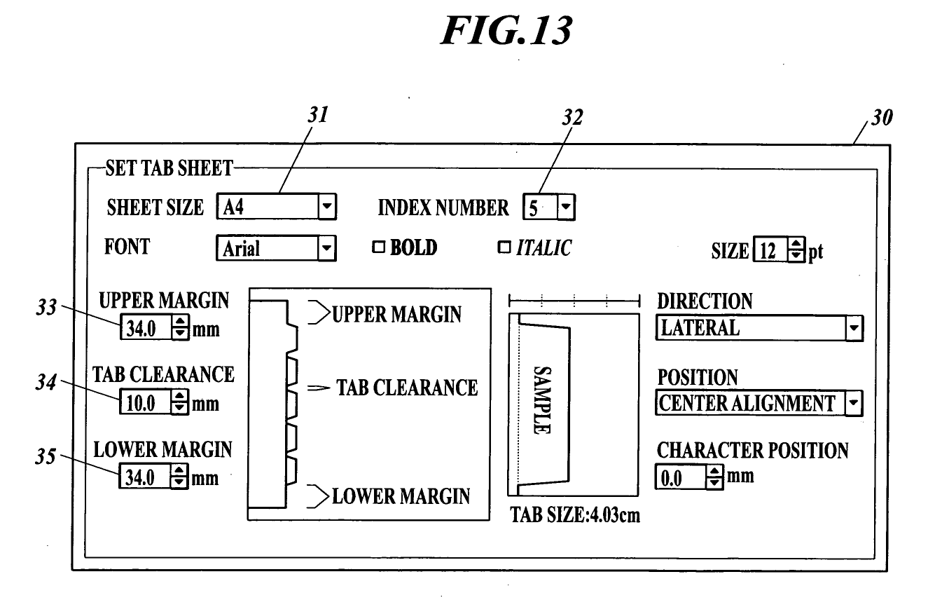

When the storage of the tab area information into the storage unit 17 is completed in the tab sheet reading processing executed in the image forming apparatus 10, the CPU 11 displays a transmission method setting screen on the operation/display unit 12 of the image forming apparatus 10. The user selects any one transmission method of the FTP, the SMB and E-mail on the transmission method setting screen. FIGS. 12A, 12B and 12C show examples of the transmission method setting screen.

When the FTP is selected in a transmission method selecting area 122 of a transmission method setting screen 121 shown in FIG. 12A, the user inputs the file name of a file in which the tab area information is stored, a server address as the address of the image forming apparatus 10, a user name, a password and a file path as information required for data transmission using the FTP. Furthermore, when the user instructs transmission of the tab area information by pushing the transmission button 123, the CPU 11 transmits the tab area information stored in association with the input file name to the PC 20 through the communication unit 15 according to the transmission instruction and the input information by using the FTP as the communication protocol.

When the SMB is selected in a transmission method selecting area 125 of a transmission method setting screen 124 shown in FIG. 12B, the user inputs the file name of a file in which the tab area information is stored, a server address as the address of the image forming apparatus 10, a user name, a password and a file path as information required for data transmission using the SMB. When the user instructs transmission of the tab area information by pushing the transmission button 126, the CPU 11 transmits the tab area information stored in association with the input file name to the PC 20 through the communication unit 15 according to the transmission instruction and the input information by using the SMB as the communication protocol.

When E-mail is selected in a transmission method selecting area 128 of a transmission method setting screen 127 shown in FIG. 12C, the user inputs the file name of a file in which the tab area information is stored, a mail address, a mail server, a user name and a password as information required for transmission of E-mail. When the user instructs transmission of the tab area information by pushing the transmission button 129, the CPU 11 attaches the tab area information stored in association with the input file name to an electronic mail and transmits it to the PC 20 indicated by a mail address through the communication unit 15 according to the transmission instruction and the input information.

When the FTP or the SMB is selected as the transmission method, the PC 20 receives and obtains a file (tab area information) transmitted from the image forming apparatus 10. When E-mail is selected as the transmission method, the PC 20 receives an electronic mail and obtains the tab area information attached to the electronic mail.

The processing steps of the tab area information display processing after the tab area information is obtained which is executed in the PC 20, and the index character input processing executed in the PC 20 are the same as the first embodiment, and thus the description thereof is omitted.

As described above, according to the print system of the second embodiment, as in the case of the first embodiment, the load imposed on the user in the tab sheet print instruction can be reduced, the tab print setting screen 231 based on the tab area information can be supplied, and the same tab-sheet preview screen as the print result can be supplied. Furthermore, any one of plural prepared transmission methods may be selected in the image forming apparatus 10, and the tab area information may be transmitted to the PC 20 according to the selected transmission method.

The above description regarding each of the embodiments is an example of the print system according to the present invention, and the present invention is not limited to these embodiments. The detailed construction and the detailed operation of the respective apparatuses constituting the system may be properly modified without departing from the subject matter of the present invention.

For example, in the respective embodiments described above, the image forming apparatus 10 serves as both the image reading apparatus and the print apparatus. However, the image reading apparatus for detecting the tab area from the tab sheet and generating the tab area information and the print apparatus for carrying out printing on the basis of print data transmitted from the PC 20 may be separately provided.

Furthermore, in the respective embodiments described above, the PC 20 obtains the sheet size, the index number, the tab width, the upper-side tab length, the lower-side tab length and the tab upper portion length of the tab sheets as the tab area information from the image forming apparatus 10. However, the PC 20 may obtain the data of the position coordinates of P1 to P4 shown in FIG. 3 together with the sheet size and the index number of the tab sheets as the tab area information from the image forming apparatus 10 and calculate the tab width, the upper-side tab length, the lower-side tab length, the tab upper portion length, the upper margin, the tab clearance, the lower margin, etc. on the basis of the obtained tab area information at the PC 20 side.

In the respective embodiments described above, a character(s) to be printed in a tab area is (are) input on the tab print setting screen 231 of the PC 20. However, an image file which is prepared in advance may be indicated or the like so that an image is input in the tab area. In this case, an image to be printed in a tab area is displayed in a tab area on the preview screen by the PC 20, whereby the same tab sheet preview screen as the print result can be supplied.

Furthermore, in the respective embodiments described above, the sheet size is detected by the sensor provided to the image reading unit 13 of the image forming apparatus 10. However, the sheet size may be detected on the basis of image data obtained by reading a tab sheet with the image reading unit 13.

What is claimed is:

1. A print instructing apparatus comprising:
a tab area information obtaining unit to obtain tab area information on a tab area of a tab sheet from an external apparatus; and
a display controlling unit to control a display unit to display based on the obtained tab area information a print setting screen for configuring a setting of the tab sheet.

2. The print instructing apparatus of claim 1, wherein the print setting screen includes a tab sheet preview screen.

3. The print instructing apparatus of claim 2, further comprising:
an input unit to receive an input of a character or image to be printed in the tab area;
a print data generating unit to generate based on the input character or image print data to print the character or image in the tab area; and
a print data transmitting unit to transmit the generated print data to a print apparatus,
wherein the display controlling unit controls the display unit to display the input character or image in a tab area on the preview screen.

4. The print instructing apparatus of claim 1, wherein the external apparatus comprises an image reading apparatus, and the tab area information is obtained by reading the tab sheet in the image reading apparatus and by detecting the tab area from the read tab sheet.

5. A print system comprising an image reading apparatus, a print instructing apparatus and a print apparatus, which are connected to one another through a communication network,
wherein the image reading apparatus comprises:
a reading unit to read a tab sheet;
a tab area detecting unit to detect a tab area from the read tab sheet; and
a tab area information transmitting unit to transmit tab area information on the detected tab area to the print instructing apparatus,
the print instructing apparatus comprises:
a tab area information obtaining unit to obtain the tab area information transmitted from the image reading apparatus;
an input unit to receive an input of a character or image to be printed in the tab area;
a display controlling unit to control a display unit to display based on the obtained tab area information a print setting screen, which includes a tab-sheet preview screen, for configuring a setting of the tab sheet, and to display the input character or image in a tab area on the preview screen displayed on the display unit;
a print data generating unit to generate based on the input character or image print data to print the character or image in the tab area; and
a print data transmitting unit to transmit the generated print data to the print apparatus, and
the print apparatus comprises:
a print data receiving unit to receive the print data transmitted from the print instructing apparatus and
a printing unit to perform printing based on the received print data.

6. A computer-readable medium embodying a program causing a computer to realize the functions of:
a tab area information obtaining function to obtain tab area information on a tab area of a tab sheet from an external apparatus; and
a display control function to control a display unit to display based on the obtained tab area information a print setting screen to configure a setting of the tab sheet.

7. The computer-readable medium of claim 6, wherein the print setting screen includes a tab sheet preview screen.

8. The computer-readable medium of claim 7, wherein the program further causes the computer to realize the functions of:
an input function to receive input of a character or image to be printed in the tab area;
a print data generating function to generate based on the input character or image print data to print the character or image in the tab area; and
a print data transmitting function to transmit the generated print data to a print apparatus,
wherein the display control function is to control the display unit to display the input character or image in a tab area on the preview screen.
